(19) United States
(12) Patent Application Publication
(10) Pub. No.: US 2020/0267973 A1
(43) Pub. Date: Aug. 27, 2020

(54) ALKALINE DISINFECTING COMPOSITIONS

(71) Applicant: GOJO Industries, Inc., Akron, OH (US)

(72) Inventors: Dewain Keith Garner, Copley, OH (US); Marisa L. Macnaughtan, Pepper Pike, OH (US); James Edmund Bingham, Akron, OH (US)

(21) Appl. No.: 16/796,990

(22) Filed: Feb. 21, 2020

Related U.S. Application Data
(60) Provisional application No. 62/808,484, filed on Feb. 21, 2019.

(51) Int. Cl. A01N 31/02; A01N 25/30; A01N 25/02

(52) U.S. Cl. CPC A01N 31/02; A01N 25/02; A01N 25/30

(57) ABSTRACT

Alkaline disinfecting compositions are provided. The alkaline disinfecting compositions contain one or more alcohols, one or more alkaline pH adjusting agents, and one or more nonionic surfactants. The alkaline disinfecting compositions have a pH of greater than 12. The alkaline disinfecting compositions achieve broad spectrum efficacy, including efficacy against C. difficile spores.

### RELATED APPLICATIONS

The present invention claims the benefits of, and priority to, U.S. Provisional Application Ser. No. 62/808,484 titled ALKALINE DISINFECTING COMPOSITIONS, which was filed on Feb. 21, 2019, and which is incorporated herein by reference in its entirety.

### FIELD

The present disclosure relates to alkaline disinfecting compositions. More particularly, the present disclosure relates to alkaline disinfecting compositions containing one or more alcohols, one or more alkaline pH adjusting agents, and one or more nonionic surfactants. The alkaline disinfecting compositions have a pH of greater than 12. The alkaline disinfecting compositions achieve broad spectrum efficacy, including efficacy against C. difficile spores.

### BACKGROUND

Disinfecting compositions have become increasingly popular with the general public not only for cleaning, but also for disinfecting surfaces in the home or workplace. It is particularly desirable to disinfect surfaces in both healthcare and foodservice applications, without the need for further rinsing or cleansing. Such disinfection may be achieved via compositions in the form of wipes, disinfecting sprays, or bulk disinfectants. Regardless of form, multi-surface compositions are desirable for the rapid disinfection of surfaces. As such, the subject disinfecting compositions must have a low toxicity rating while providing rapid efficacy against bacteria, viruses, and fungi. Further, the disinfecting compositions must exhibit certain aesthetics that users desire in surface cleansers, such as minimal visual residue and minimal odor generation following use. These disinfecting compositions must likewise maintain these desirable characteristics (i.e., minimal visual residue and minimal odor generation) even upon using other cleaning follow-on products, such as wipes.

In environments specific to healthcare, serious infections are of particular concern. Such infections may be generally referred to as healthcare-associated infections (HAIs). While most types of HAIs are declining, one infection, caused by the bacteria Clostridum difficile (C. difficile), remains at historically high levels. C. difficile is a spore-forming, gram-positive anaerobic bacillus of the human intestine and is thought to be present in 2-5% of the adult population. Pathogenic C. difficile strains produce multiple toxins, the most well-characterized of which are enterotoxin (C. difficile toxin A) and cytotoxin (C. difficile toxin B), both of which can produce diarrhea and inflammation in infected patients. The emergence of a new, highly toxic strain of C. difficile, resistant to fluoroquinolone antibiotics, such as ciprofloxacin and levofloxacin have also been reported. C. difficile infection causes diarrhea and other intestinal problems and is linked to 14,000 deaths in the United States each year.

A variety of strategies have been proposed to kill C. difficile spores on various surfaces, with limited success. Bleach-based compositions have been employed for hard surfaces and have been shown to reduce the environmental burden of C. difficile, but can be corrosive and degrade surfaces. Hydrogen peroxide-based compositions have also been proposed, including combinations of hydrogen peroxide and peracetic acid, a combination of hydrogen peroxide and silver cation dry-mist system, and other “improved” hydrogen peroxide formulations. However, peracids generally have poor stability, corrosive properties, and irritating odors. Hydrogen peroxide is also prone to decomposition, and concentrated solutions can be highly corrosive.

Thus, a need remains for more stable, less corrosive compositions having good efficacy against C. difficile spores. Moreover, it is desirable for such compositions to maintain the aesthetic properties and ease of use desirable for rapidly disinfecting surfaces in any environment, i.e., minimal visual residue, multi-surface use, and low odor generation.

### SUMMARY

The general inventive concepts are directed to alkaline disinfecting compositions. The alkaline disinfecting compositions have a pH of greater than 12, and contain one or more alcohols, one or more alkaline pH adjusting agents, and one or more nonionic surfactants. In embodiments of the present disclosure, the compositions are devoid of fatty acid surfactants and fatty acid-derived surfactants, i.e., the compositions exclude fatty acid surfactants and fatty acid-derived surfactants. In embodiments of the present disclosure, the one or more nonionic surfactants comprise alcohol ethoxylates, alcohol propoxylates, or combinations thereof. In other embodiments of the present disclosure, the one or more nonionic surfactants comprise alkyl polyglucosides.

### DESCRIPTION OF THE FIGURES

The advantages of the inventive concepts will be apparent upon consideration of the following detailed disclosure, especially when taken in conjunction with the accompanying drawings wherein:

FIG. 1 is a graphical representation of the efficacy of five exemplary alkaline disinfecting compositions at various pH levels against Staphylococcus aureus (S. aureus);

FIG. 2 is an image depicting the shelf-stability of two exemplary alkaline disinfecting compositions versus one comparative composition;

FIG. 3 is an image depicting the visual residue of two exemplary alkaline disinfecting compositions versus one comparative composition; and

FIG. 4 is a chart showing the perceived odor intensity of two exemplary alkaline disinfecting compositions, one comparative composition, and one untreated control.

### DETAILED DESCRIPTION

Disclosed herein are alkaline disinfecting compositions. While the present disclosure describes certain embodiments of the alkaline disinfecting compositions in detail, the present disclosure is to be considered exemplary and is not intended to be limited to the disclosed embodiments.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

To the extent that the term “includes” or “including” is used in the description or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Furthermore, when the phrase “one or more of A and B” is employed it is intended to mean “only A, only B, or both A and B.” Similarly, when the phrase “at least one of A, B, and C” is employed it is intended to mean “only A, only B, only C, or any combination of A, B, and C” (e.g., A and B; B and C; A and C; A, B, and C).

The alkaline disinfecting compositions of the present disclosure can comprise, consist of, or consist essentially of the essential elements of the disclosure as described herein, as well as any additional or optional element described herein, or which is otherwise useful in disinfecting applications.

All percentages, parts, and ratios as used herein are by weight of the total formulation, unless otherwise specified.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

The general inventive concepts relate to alkaline disinfecting compositions. More particularly, the inventive concepts relate to alkaline disinfecting compositions containing one or more alcohols, one or more alkaline pH adjusting agents, and one or more nonionic surfactants. The alkaline disinfecting compositions have a pH of greater than 12, and achieve broad spectrum efficacy, including efficacy against C. difficile spores.

In accordance with the present disclosure, the alkaline disinfecting compositions comprise one or more alcohols. The term “alcohol,” as used herein, constitutes any compound containing at least one carbon bonded to at least one hydroxyl group, i.e., any molecule having the structure R₁R₂R₃C—OH, including linear or branched compounds. The identity of the “R” groups, i.e., R₁ R₂ and R₃ groups, are not particularly limited, as it has been found that the concentration of alkoxide produced via the equilibrium reaction between the one or more alcohols and the one or more alkaline pH adjusting agents, in the presence of a nonionic surfactant, may contribute to the efficacy of the alkaline disinfecting compositions. As used herein, the term “alkoxide” describes any deprotonated alcohol, i.e., any molecule having the structure R₁R₂R₃C—O⁽⁻⁾ and existing in an equilibrium reaction as set forth below:

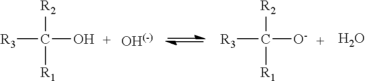

In accordance with the present disclosure, the alkaline disinfecting compositions may comprise one or more monohydric alcohols. In accordance with the present disclosure, the alkaline disinfecting compositions may alternatively, or additionally, comprise one or more diols. In accordance with the present disclosure, the alkaline disinfecting compositions may alternatively, or additionally, comprise one or more polyhydric alcohols including, as non-limiting examples, C2-C8 hydrotropes, such as C2-C6 polyols and glycols including butylene glycol, propylene glycol, ethylene glycol, and other such polyols and glycols, and combinations and derivatives thereof. In accordance with the present disclosure, the alkaline disinfecting compositions may comprise any monohydric or polyhydric alcohols with varying functional group substitution along the carbon chain, including but not limited to, amines, quaternary ammoniums, amides, carboxylic acids, aryl, substituted aryl, cyclic alkyls, thiols, thioethers, alkanes, alkenes, alkynes, ethers, alkyl halides, aldehydes, ketones, anhydrides, esters, nitriles, nitro alkanes, nitrites, nitrates, amine oxides, isocyantes, phosphates, phosphines, phosphine oxides, phosphites, boranes, borates, silanes, siloxides, sulfonates, sulfates and combinations and derivatives thereof.

In accordance with the present disclosure, the alkaline disinfecting compositions may comprise one or more C₁-C₁₀ alcohols, i.e., alcohols containing 1 to 10 carbon atoms. In accordance with the present disclosure, the alkaline disinfecting compositions may comprise one or more C₁-C₈ alcohols. In accordance with the present disclosure, the alkaline disinfecting compositions may comprise one or more C₁-C₆ alcohols. Such C₁-C₆ alcohols may be referred to as lower alkanols, and are distinct from long-chain alcohols (i.e., fatty alcohols). Examples of lower alkanols include, but are not limited to, methanol, ethanol, propanol, butanol, pentanol, hexanol, and isomers and mixtures thereof. In some embodiments, the one or more C₁-C₆ alcohols comprise methanol, ethanol, propanol, or butanol, or isomers or mixtures thereof. In some embodiments, the one or more C₁-C₆ alcohols comprise, or consist of, isopropanol. In some embodiments, the one or more C₁-C₆ alcohols comprise, or consist of, ethanol. In some embodiments, the compositions comprise a mixture of alcohols. In some embodiments, the compositions comprise, or consist of, a mixture of ethanol and isopropanol. In some embodiments, the compositions comprise a mixture of isopropanol and n-propanol.

In some embodiments, the one or more alcohols consist of ethanol. As used herein, the term “ethoxide” describes deprotonated ethanol existing in an equilibrium reaction as set forth below:

C₂H₅OH+OH⁽⁻⁾ [symbol] C₂H₅O⁽⁻⁾+H₂O

In accordance with the present disclosure, the alkaline disinfecting compositions comprise up to 95 weight percent (wt. %) of one or more alcohols, based upon the total weight of the composition. In some embodiments, the alkaline disinfecting compositions comprise up to 75 wt. % of one or more alcohols, based upon the total weight of the composition. In some embodiments, the alkaline disinfecting compositions comprise up to 60 wt. % of one or more alcohols, based upon the total weight of the composition. In some embodiments, the alkaline disinfecting compositions comprise up to 40 wt. % of one or more alcohols, based upon the total weight of the composition. In some embodiments, the alkaline disinfecting compositions comprise up to 30 wt. % of one or more alcohols, based upon the total weight of the composition. In some embodiments, the alkaline disinfecting compositions comprise at least 0.1 wt. % of one or more alcohols, based upon the total weight of the composition. In some embodiments, the alkaline disinfecting compositions comprise at least 5 wt. % of one or more alcohols, based upon the total weight of the composition. In some embodiments, the alkaline disinfecting compositions comprise at least 10 wt. % of one or more alcohols, based upon the total weight of the composition. In some embodiments, the alkaline disinfecting compositions comprise at least 15 wt. % of one or more alcohols, based upon the total weight of the composition. In some embodiments, the alkaline disinfecting compositions comprise at least 20 wt. % of one or more alcohols, based upon the total weight of the composition. In some embodiments, the alkaline disinfecting compositions comprise from 0.1 to 95 wt. % of one or more alcohols, based upon the total weight of the composition. In some embodiments, the alkaline disinfecting compositions comprise from 5 to 95 wt. % of one or more alcohols, based upon the total weight of the composition. In some embodiments, the alkaline disinfecting compositions comprise from 5 to 75 wt. % of one or more alcohols, based upon the total weight of the composition. In some embodiments, the alkaline disinfecting compositions comprise from 5 to 60 wt. % of one or more alcohols, based upon the total weight of the composition. In some embodiments, the alkaline disinfecting compositions comprise from 70 to 90 wt. % of one or more alcohols, based upon the total weight of the composition. In some embodiments, the alkaline disinfecting compositions comprise from 15 to 45 wt. % of one or more alcohols, based upon the total weight of the composition. In some embodiments, the alkaline disinfecting compositions comprise from 15 to 35 wt. % of one or more alcohols, based upon the total weight of the composition. In some embodiments, the alkaline disinfecting compositions comprise from 15 to 30 wt. % of one or more alcohols, based upon the total weight of the composition. In some embodiments, the alkaline disinfecting compositions comprise from 18 to 30 wt. % of one or more alcohols, based upon the total weight of the composition. In some embodiments, the alkaline disinfecting compositions comprise from 20 to 30 wt. % of one or more alcohols, based upon the total weight of the composition.

In some embodiments, the alkaline disinfecting compositions are formulated as surface spray compositions comprising from 0.1 to 95 wt. % of one or more C₁-C₆ alcohols, based upon the total weight of the composition. In some embodiments, the alkaline disinfecting compositions are formulated as surface spray compositions comprising from 15 to 35 wt. % of one or more C₁-C₆ alcohols, based upon the total weight of the composition. In some embodiments, the alkaline disinfecting compositions are formulated as surface spray compositions comprising from 15 to 30 wt. % of one or more C₁-C₆ alcohols, based upon the total weight of the composition. In some embodiments, the alkaline disinfecting compositions are formulated as surface spray compositions comprising from 20 to 30 wt. % of one or more C₁-C₆ alcohols, based upon the total weight of the composition. In some embodiments, the alkaline disinfecting compositions are formulated as surface spray compositions comprising from 0.1 to 95 wt. % of ethanol, based upon the total weight of the composition. In some embodiments, the alkaline disinfecting compositions are formulated as surface spray compositions comprising from 15 to 35 wt. % of ethanol, based upon the total weight of the composition. In some embodiments, the alkaline disinfecting compositions are formulated as surface spray compositions comprising from 15 to 30 wt. % of ethanol, based upon the total weight of the composition. In some embodiments, the alkaline disinfecting compositions are formulated as surface spray compositions comprising from 20 to 30 wt. % of ethanol, based upon the total weight of the composition

In some embodiments, the alkaline disinfecting compositions are delivered in or on a wipe, the compositions comprising from 0.1 to 95 wt. % of one or more C₁-C₆ alcohols, based upon the total weight of the composition. In some embodiments, the alkaline disinfecting compositions are delivered in or on a wipe, the compositions comprising from 15 to 35 wt. % of one or more C₁-C₆ alcohols, based upon the total weight of the composition. In some embodiments, the alkaline disinfecting compositions are delivered in or on a wipe, the compositions comprising from 15 to 30 wt. % of one or more C₁-C₆ alcohols, based upon the total weight of the composition. In some embodiments, the alkaline disinfecting compositions are delivered in or on a wipe, the compositions comprising from 20 to 30 wt. % of one or more C₁-C₆ alcohols, based upon the total weight of the composition. In some embodiments, the alkaline disinfecting compositions are delivered in or on a wipe, the compositions comprising from 0.1 to 95 wt. % of ethanol, based upon the total weight of the composition. In some embodiments, the alkaline disinfecting compositions are delivered in or on a wipe, the compositions comprising from 15 to 35 wt. % of ethanol, based upon the total weight of the composition. In some embodiments, the alkaline disinfecting compositions are delivered in or on a wipe, the compositions comprising from 15 to 30 wt. % of ethanol, based upon the total weight of the composition. In some embodiments, the alkaline disinfecting compositions are delivered in or on a wipe, the compositions comprising from 20 to 30 wt. % of ethanol, based upon the total weight of the composition

In accordance with the present disclosure, the alkaline disinfecting compositions comprise one or more alkaline pH adjusting agents. In general, the term “alkaline pH adjusting agent” as used herein refers to any compound that interacts with water to create an OH⁽⁻⁾ ion. Suitable alkaline pH adjusting agents include, but are not limited to, hydroxides such as sodium hydroxide, potassium hydroxide, calcium hydroxide, lithium hydroxide, magnesium hydroxide, ammonium hydroxide, tetraalkylammonium hydroxide, tetraarylammonium hydroxide, choline hydroxide, and combinations thereof; metal oxides such as calcium oxide and sodium oxide; conjugate bases of weak acids such as dipotassium phosphate, disodium phosphate, magnesium carbonate, pentapotassium triphosphate, pentasodium trisphosphate, potassium carbonate, sodium carbonate, tetrapotassium pyrophosphate, tetrasodium pyrophosphate, and trisodium phosphate; trialkyl/arylamine, monoethanolamine, diethanolamine, triethanolamine, sodium silicates, sodium tetraborates, sodium alkoxides, potassium alkoxides, sodium aryloxides, and like compounds having a sodium, potassium, lithium, calcium or magnesium cation. In some embodiments, the one or more alkaline pH adjusting agents comprise, or consist of, one or more of potassium hydroxide and sodium hydroxide. In some embodiments, the one or more alkaline pH adjusting agents comprise, or consist of, sodium hydroxide.

In accordance with the present disclosure, the alkaline disinfecting compositions comprise up to 10 wt. % of one or more alkaline pH adjusting agents, based upon the total weight of the composition. In some embodiments, the alkaline disinfecting compositions comprise up to 5 wt. % of one or more alkaline pH adjusting agents, based upon the total weight of the composition. In some embodiments, the alkaline disinfecting compositions comprise up to 1 wt. % of one or more alkaline pH adjusting agents, based upon the total weight of the composition. In some embodiments, the alkaline disinfecting compositions comprise from 0.01 to 10 wt. % of one or more alkaline pH adjusting agents, based upon the total weight of the composition. In some embodiments, the alkaline disinfecting compositions comprise from 0.05 to 5 wt. % of one or more alkaline pH adjusting agents, based upon the total weight of the composition. In some embodiments, the alkaline disinfecting compositions comprise from 0.05 to 1 wt. % of one or more alkaline pH adjusting agents, based upon the total weight of the composition. In some embodiments, the alkaline disinfecting compositions comprise from 0.1 to 0.8 wt. % of one or more alkaline pH adjusting agents, based upon the total weight of the composition.

In accordance with the present disclosure, the alkaline disinfecting compositions comprise one or more surfactants. In accordance with the present disclosure, the one or more surfactants comprise, or consist of, one or more nonionic surfactants. In some embodiments, the alkaline disinfecting compositions are devoid of anionic surfactants, i.e., the compositions exclude anionic surfactants.

In some embodiments, the one or more nonionic surfactants comprise, or consist of, one or more alcohol ethoxylates, alcohol propoxylates, and combinations thereof. In some embodiments, the nonionic surfactants comprise, or consist of, one or more alkyl polyglucosides. In some embodiments, the nonionic surfactants may comprise poly(alkylene-oxide) block copolymers, oligomeric alkyl poly(ethylene oxide), oligomeric akyl poly(propylene oxide), alkyl-phenol poly (ethylene oxide), amine oxides, sorbitan esters, alkyl amide ethoxylates, alkyl amine ethoxylates, betaines, lecithin, amino acetates, long chain alcohols, long chain diols, and combinations thereof.

In accordance with the present disclosure, the one or more nonionic surfactants may comprise, or consist of, one or more alcohol ethoxylates, alcohol propoxylates, and combinations thereof. In accordance with the present disclosure, the one or more nonionic surfactants may be characterized by a hydrophilic-lipophilic balance (“HLB”) value of less than 13, including an HLB value of from greater than 8 to less than 13. In some embodiments, the one or more nonionic surfactants may comprise branched alcohol ethoxylates or linear alcohol ethoxylates. In some embodiments, the one or more nonionic surfactants may comprise a C8-C14 linear alcohol ethoxylate. In some embodiments, the one or more nonionic surfactants may comprise a C10-C12 linear alcohol ethoxylate. In some embodiments, the one or more nonionic surfactants may comprise, or consist of, a C11 linear alcohol ethoxylate surfactant. In some embodiments, the one or more nonionic surfactants may comprise, or consist of, fatty alcohol polyethylene glycols. In some embodiments, the one or more nonionic surfactants may comprise, or consist of, PEG-7 Lauryl Ether, which is sometimes referred to as Laureth-7. In some embodiments, the one or more nonionic surfactants may comprise, or consist of, PEG-9 tridecyl ether, which is sometimes referred to as Trideceth-9.

In accordance with the present disclosure, the one or more nonionic surfactants may comprise, or consist of, one or more alkyl polyglucosides. The class of alkyl polyglucosides (“APG”) are derived from a glucose sugar and a fatty alcohol, including in which the alkyl group contains 8-18 carbon atoms, glycerol fatty acid esters, polyoxyethylene glycerol fatty acid esters, polyoxyethylene sorbitan fatty acid esters, polyethylene glycol fatty acid esters and polyoxyethylene polyoxypropylene block copolymers with terminal hydroxyl groups and combinations thereof. In some embodiments, the one or more nonionic surfactants may comprise C8-14 alkyl polyglucoside surfactants, including a C8-12 alkyl polyglucoside surfactants and C8-10 alkyl polyglucoside surfactants. In some embodiments, the one or more nonionic surfactants may comprise, or consist of, an octyl decyl glucoside surfactant, which is a C8-10 alkyl polyglucoside surfactant. In some embodiments, the one or more nonionic surfactants may comprise, or consist of, a caprylyl glucoside and decyl glucoside surfactant. In some embodiments, the one or more nonionic surfactants may comprise, or consist of, a naturally derived C8-10 alkyl polyglucoside surfactant.

In accordance with the present disclosure, the compositions are devoid of fatty acid-derived surfactants, i.e., the compositions exclude fatty acid-derived surfactants. As used herein, the terms “fatty acid surfactants” and “fatty acid-derived surfactants” are inclusive and used interchangeably to mean a fatty acid surfactant or a derivative thereof. Fatty acid-derived surfactants may be anionic surfactants. Specifically, in accordance with the present disclosure, the alkaline disinfecting compositions may be devoid of lauric acid and salts or derivatives of lauric acid. Lauric acid is also commonly known as dodecanoic acid. In some cases, it has been found that the anionic carboxylate functional group of lauric acid-derived surfactants may produce a distinct unpleasant odor when protonated. For example, in some cases it has been found that upon using a follow-on cleaning product (i.e., a wipe), compositions comprising a lauric acid-derived surfactant produce a distinct unpleasant odor. Likewise, in some cases, it has been found that the anionic carboxylate functional group of lauric acid-derived surfactants may result in a visual residue remaining on surfaces following the use of a composition comprising such surfactants. Such residue, or film, left behind has been found undesirable by users. Further, such lauric acid-derived surfactants have been found to be less effective at cleaning surfaces, less effective at disinfecting, less effective at solubilizing dirt, and less effective at wetting surfaces on a pound for pound basis than the alkaline disinfecting compositions disclosed herein. In addition, compositions made with lauric acid-derived surfactants exhibit undesirable characteristics upon storage, such as yellowing.

In accordance with the present disclosure, the alkaline disinfecting compositions comprise up to 10 wt. % of one or more nonionic surfactants, based upon the total weight of the composition. In some embodiments, the alkaline disinfecting compositions comprise up to 5 wt. % of one or more nonionic surfactants, based upon the total weight of the composition. In some embodiments, the alkaline disinfecting compositions comprise up to 1 wt. % of one or more nonionic surfactants, based upon the total weight of the composition. In some embodiments, the alkaline disinfecting compositions comprise from 0.01 to 10 wt. % of one or more nonionic surfactants, based upon the total weight of the composition. In some embodiments, the alkaline disinfecting compositions comprise from 0.01 to 5 wt. % of one or more nonionic surfactants, based upon the total weight of the composition. In some embodiments, the alkaline disinfecting compositions comprise from 0.05 to 5 wt. % of one or more nonionic surfactants, based upon the total weight of the composition. In some embodiments, the alkaline disinfecting compositions comprise from 0.03 to 3 wt. % of one or more nonionic surfactants, based upon the total weight of the composition. In some embodiments, the alkaline disinfecting compositions comprise from 0.05 to 2 wt. % of one or more nonionic surfactants, based upon the total weight of the composition. In some embodiments, the alkaline disinfecting compositions comprise from 0.05 to 1 wt. % of one or more nonionic surfactants, based upon the total weight of the composition. In some embodiments, the alkaline disinfecting compositions comprise from 0.1 to 0.8 wt. % of one or more nonionic surfactants, based upon the total weight of the composition. In some embodiments, the alkaline disinfecting compositions comprise from 0.1 to 0.6 wt. % of one or more nonionic surfactants, based upon the total weight of the composition. In some embodiments, the alkaline disinfecting compositions comprise from 0.3 to 0.6 wt. % of one or more nonionic surfactants, based upon the total weight of the composition. As used herein, the weight percentages are based upon percent solids of the composition.

In accordance with the present disclosure, the alkaline disinfecting compositions comprise water quantum sufficit (q.s.). In some embodiments, the alkaline disinfecting compositions comprise at least 40 wt. % water. In some embodiments, the alkaline disinfecting compositions comprise at least 50 wt. % water. In some embodiments, the alkaline disinfecting compositions comprise at least 60 wt. % water. In some embodiments, the alkaline disinfecting compositions comprise at least 70 wt. % water. In some embodiments, the alkaline disinfecting compositions comprise at least 75 wt. % water. In some embodiments, the alkaline disinfecting compositions comprise from 40 to 90 wt. % water. In some embodiments, the alkaline disinfecting compositions comprise from 50 to 80 wt. % water. In some embodiments, the alkaline disinfecting compositions comprise from 60 to 75 wt. % water. In some embodiments, the alkaline disinfecting compositions comprise from 65 to 75 wt. % water. More or less water may be required in certain instances, depending particularly on other ingredients and/or the amounts thereof employed.

In accordance with the present disclosure, the pH value obtained is a potentiometric pH, and the actual proton activity may vary from a fully aqueous system. In accordance with the present disclosure, the alkaline disinfecting compositions may have a pH of 12 or greater. In accordance with the present disclosure, the alkaline disinfecting compositions may have a pH of greater than 12. In some embodiments, the alkaline disinfecting compositions may have a pH of from greater than 12 to less than 14. In some embodiments, the alkaline disinfecting compositions may have a pH of from 12.1 to 13.9. In some embodiments, the alkaline disinfecting compositions may have a pH of from 12.5 to 13.9. In some embodiments, the alkaline disinfecting compositions may have a pH of from 12.7 to 13.9. In some embodiments, the alkaline disinfecting compositions may have a pH of from greater than 13 to less than 14. In some embodiments, the alkaline disinfecting compositions may have a pH of from 13.1 to 13.9. In some embodiments, the alkaline disinfecting compositions may have a pH of from 13.5 to 13.9.

The alkaline disinfecting compositions of the present invention can further comprise a wide range of optional additives, with the proviso that they do not deleteriously affect the compositions' ability to disinfect surfaces or increase the visible residue on surfaces. The CTFA International Cosmetic Ingredient Dictionary and Handbook, Eleventh Edition 2005, and the 2004 CTFA International Buyer's Guide, describe a wide variety of non-limiting cosmetic and pharmaceutical ingredients commonly used in the skin care industry, that are suitable for use in the compositions of the present invention. Nonlimiting examples of functional classes of ingredients are described at page 537 of this reference. Examples of these functional classes include: abrasives, anticaking agents, antioxidants, antipruritics, binders, biological additives, bulking agents, chelating agents, chemical additives, colorants, denaturants, emulsifiers, film formers, fragrance components, humectants, opacifying agents, plasticizers, preservatives (sometimes referred to as antimicrobials), propellants, reducing agents, skin-conditioning agents (emollient, miscellaneous, and occlusive), solvents, foam boosters, hydrotropes, solubilizing agents, suspending agents (nonsurfactant), ultraviolet light absorbers, rheology modifying agents, including salts and polymers, detackifiers, and viscosity increasing agents (aqueous and nonaqueous). Some exemplary humectants may include C₆₋₁₀ alkane diols, glyceryl caprylate/caprate, and glycerin. Examples of other functional classes of materials that may be useful herein include sequestrants, keratolytics, topical active ingredients, and the like. The compositions may also include corrosion inhibitors such as, for example, inorganic sulfates, inorganic silicates, inorganic borates, or inorganic phosphates.

In accordance with the present disclosure, the alkaline disinfecting compositions may further include a number of optional “primary” enhancers, including, e.g., protein denaturants, chaotropic agents, and amine-containing enhancers, α-aminoacids, salts of alkali metals, salts of alkaline earth metals. Exemplary amine-containing enhancers include urea, thiourea, dimethyl urea, guanidine-HCl, guanidine thiocyanate, aminoguanidine bicarbonate, guanidine carbonate, guanidine phosphate, L-NG-nitroarginine, and aminoguanidine-HCL. Exemplary α-aminoacids include sulfur-containing aminoacids and nitro-containing aminoacids. Exemplary sulfur-containing aminoacids include L-cysteine and methionine. Exemplary nitro-containing aminoacids include L-NG-nitroarginine. Examples of α-aminoacids include α-aminoacid chelators. Exemplary α-aminoacid chelators include the trisodium salt of methylglycinediacetic acid (Na₃MGDA). Na₃MGDA is commercially available under the trade name Trilon M from BASF. Further exemplary enhancers include choline salts, catechols, and diols, including, e.g., 1,2-diols, 1,3-diols, and 1,4-diols, ammonia, cyanuric acid, hydantoin, chelators, glycerol, and glycolic acid.

Embodiments of the present disclosure include the alkaline disinfecting compositions formulated as a surface spray. Other embodiments of the present disclosure include the alkaline disinfecting compositions delivered in or on a wipe, i.e. a tissue or cloth that is wiped over a surface. In general, the physical form of the alkaline disinfecting compositions is not particularly limited, and in one or more embodiments, the compositions may be formed as a liquid that is poured, pumped, sprayed, or otherwise dispensed, including liquid concentrates and dilutable liquids. Other embodiments of the present disclosure include the alkaline disinfecting compositions formulated as a gel. Other embodiments of the present disclosure include the alkaline disinfecting compositions formulated as an aerosol. Other embodiments of the present disclosure include the alkaline disinfecting compositions formulated as a foam, including both aerosol and non-aerosol foams. The alkaline disinfecting compositions of the present invention may be employed on a wide variety of surfaces or substrates, including hard surfaces, soft surfaces, non-living (inanimate) surfaces, living tissue, skin, soil, porous, and non-porous surfaces. In the present disclosure, it is understood that the term “surface” includes skin. Embodiments of the present disclosure may be employed to disinfect or otherwise disinfect inanimate objects, i.e. surfaces such as instruments, medical equipment, furniture, handrails, textiles, etc.

The alkaline disinfecting compositions achieve broad spectrum efficacy, including efficacy against C. difficile spores. Unless otherwise specified, the term “efficacy” with respect to C. difficile spores includes either killing or deactivating C. difficile spores, or both. In this respect, either sporicidal or sporostatic efficacy against C. difficile spores, or both, may be observed, unless otherwise specified.

Unless otherwise specified, the term “log reduction” as used herein refers to log 10 reduction. In accordance with the present disclosure, the alkaline disinfecting compositions provide a log reduction against C. difficile spores of at least 3 in less than 10 minutes. To achieve this reduction in spores, the amount of alkaline disinfecting composition to be applied to the target surface is not particularly limited. At a minimum, a sufficient amount of alkaline disinfecting composition should be applied to substantially wet the surface such that the surface will remain wet for the desired contact time, noting that there will be some evaporation of the alkaline disinfecting composition.

In one or more embodiments, the alkaline disinfecting compositions are also effective in killing Gram negative and Gram positive bacteria, fungi, yeast, mold, non-enveloped and enveloped viruses. In one or more embodiments, the alkaline disinfecting compositions have rapid antimicrobial efficacy against bacteria such as Staphylococcus aureus, methicillin-resistant S. aureus, Escherichia coli, Pseudomonas aeruginosa, Serratia marcescens, yeast such as Candida albicans, mold such as Aspergillus niger, fungi such as Trichophyton mentagrophytes, enveloped viruses such as Influenza A virus, and non-enveloped viruses such as Respiratory syncytial virus, Rhinovirus and Feline Calicivirus

In one embodiment of the present disclosure, a sprayable composition is disclosed. The sprayable composition comprises from 20 to 40 wt. % of one or more C₁-C₆ alcohols, based upon the total weight of the composition; from 0.1 to 0.8 wt. % of one or more alkaline pH adjusting agents, based upon the total weight of the composition; from 0.1 to 0.8 wt. % of one or more nonionic surfactants comprising one or more of alcohol ethoxylates, alcohol propoxylates, and alkyl polyglucosides; and from 60 to 80 wt. % water, based upon the total weight of the composition, wherein the composition has a pH of from greater than 12 to less than 14, and wherein the composition is devoid of fatty acid-derived surfactants. The sprayable composition may consist of the one or more C₁-C₆ alcohols, the one or more alkaline pH adjusting agents, the one or more nonionic surfactants, and the water. In some embodiments, the one or more nonionic surfactants may consist of one or more alcohol ethoxylates. In other embodiments, the one or more nonionic surfactants may consist of one or more alcohol ethoxylates.

In one embodiment of the present disclosure, a sprayable composition is disclosed. The sprayable composition comprises from 15 to 35 wt. % of one or more C₁-C₆ alcohols, based upon the total weight of the composition; from 0.01 to 10 wt. % of one or more alkaline pH adjusting agents, based upon the total weight of the composition; and from 0.01 to 10 wt. % of one or more nonionic surfactants comprising one or more of alcohol ethoxylates, alcohol propoxylates, and alkyl polyglucosides, wherein the composition has a pH of greater than 12, and wherein the composition is devoid of fatty acid-derived surfactants. The composition may have a pH of from greater than 12 to less than 14, or a pH of from 12.1 to 13.9. In some embodiments, the one or more nonionic surfactants may consist of one or more C8-C14 linear alcohol ethoxylates. In other embodiments, the one or more nonionic surfactants may consist of one or more C8-14 alkyl polyglucoside surfactants.

In one embodiment of the present disclosure, a composition comprising: from 5 to 95 wt. % of one or more C₁-C₆ alcohols, based upon the total weight of the composition; one or more alkaline pH adjusting agents; and one or more nonionic surfactants comprising one or more of alcohol ethoxylates, alcohol propoxylates, and alkyl polyglucosides is disclosed, wherein the composition has a pH of greater than 12. In some embodiments, the one or more nonionic surfactants may be selected from the group consisting of branched alcohol ethoxylates or linear alcohol ethoxylates, and may consist of one or more C8-C14 linear alcohol ethoxylates. In other embodiments, the one or more nonionic surfactants may consist of one or more alkyl polyglucosides, and may consist of one or more C8-14 alkyl polyglucoside surfactants. The one or more C₁-C₆ alcohols may comprise methanol, ethanol, propanol, butanol, pentanol, hexanol, and isomers and mixtures thereof. The one or more C₁-C₆ alcohols comprise from 15 to 35 wt. %, based upon the total weight of the composition. The one or more nonionic surfactants may comprise from 0.01 to 10 wt. %, based upon the total weight of the composition. The one or more alkaline pH adjusting agents may comprise from 0.01 to 10 wt. %, based upon the total weight of the composition. The composition may further comprise from 5 to 90 wt. % water, based upon the total weight of the composition.

In one embodiment of the present disclosure, a method for the disinfection of surfaces is disclosed. The method comprises contacting the surface with a composition comprising: from 5 to 95 wt. % of one or more alcohols, based upon the total weight of the composition; one or more alkaline pH adjusting agents; and one or more nonionic surfactants, wherein the composition has a pH of greater than 12, and wherein the composition is devoid of fatty acid-derived surfactants. The composition may have a pH of from greater than 12 to less than 14, or a pH of from 12.1 to 13.9. The one or more alcohols may comprise from 15 to 35 wt. %, based upon the total weight of the composition. The one or more nonionic surfactants may comprise from 0.01 to 10 wt. %, based upon the total weight of the composition. The one or more alkaline pH adjusting agents may comprise from 0.01 to 10 wt. %, based upon the total weight of the composition.

In one embodiment of the present disclosure, a composition comprising from 5 to 95 wt. % of one or more alcohols, based upon the total weight of the composition; one or more alkaline pH adjusting agents; and one or more nonionic surfactants is disclosed, wherein the composition has a pH of greater than 12, and wherein the composition is devoid of fatty acid-derived surfactants. The composition may have a pH of from greater than 12 to less than 14, or a pH of from 12.1 to 13.9. The one or more alcohols may comprise from 15 to 35 wt. %, based upon the total weight of the composition. The one or more nonionic surfactants may comprise from 0.01 to 10 wt. %, based upon the total weight of the composition. The one or more alkaline pH adjusting agents may comprise from 0.01 to 10 wt. %, based upon the total weight of the composition.

The general inventive concepts have been described above both generally and with regard to various specific exemplary embodiments. Although the general inventive concepts have been set forth in what are believed to be exemplary illustrative embodiments, a wide variety of alternatives will be apparent to those of skill in the art from reading this disclosure. The general inventive concepts are not otherwise limited, except for those instances when presented in specific claims.

### EXAMPLES

The following examples are included for the purposes of illustration, and do not limit the scope of the general inventive concepts described herein.

### Example 1

Five formulations were prepared having identical compositions (i.e., ethanol, APG surfactant, pH adjusting agent, and water), for the purpose of evaluating the effectiveness of exemplary APG surfactant-based compositions at various pH levels. The composition of each formulation was identical apart from the amount of potassium hydroxide pH adjusting agent used to achieve the given pH. The effectiveness of the alkaline disinfecting compositions on hard, non-porous, inanimate environmental surfaces was studied according to the AOAC 961.02 test method for the surface sprays. Test cultures of Staphylococcus aureus (S. aureus) ATCC 6538 were used to test each compositions' efficacy, with a contact time of 10 minutes for Sprays 1 through 4, and of 1 minute for Spray 5. The results, set forth in Table 1, are expressed as a fraction of carriers that exhibited growth, e.g., percent positive carriers.

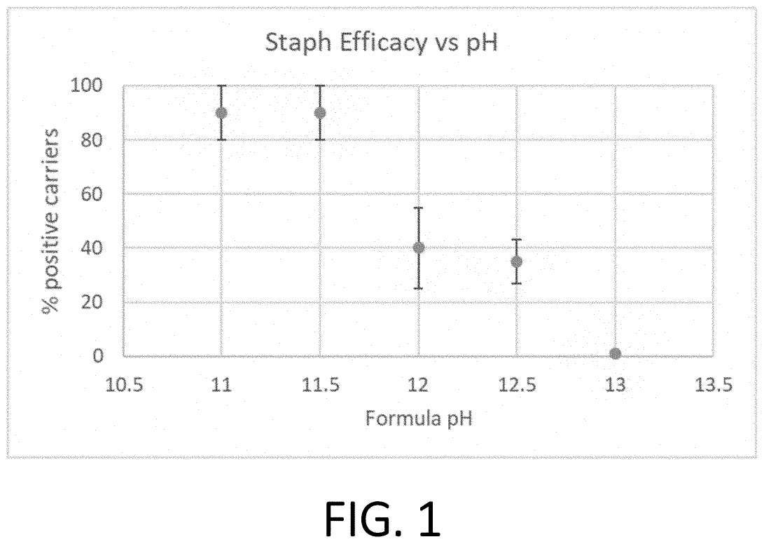

As shown numerically in Table 1 and graphically in FIG. 1, there is a significant increase in activity at a pH of 12, which indicates a more effective disinfecting formulation at a pH at and above this point.

| | | Contact | | | % |
|---|---|---|---|---|---|
| | pH | Time | Positive | Total | Positive |
| Spray 1 | 11 | 10 min. | 36 | 40 | 90% |
| Spray 2 | 11.5 | | 36 | 40 | 90% |
| Spray 3 | 12 | | 8 | 20 | 40% |
| Spray 4 | 12.5 | | 14 | 40 | 35% |
| Spray 5 | 13 | 1 min. | 2 | 140 | 1% |

### Example 2

Three fragrance-free surface sprays were prepared having identical compositions apart from the type of surfactant, as shown in Table 2. Each spray was prepared using identical amounts of ethanol and surfactant. The pH of each spray was adjusted to 13.1 using potassium hydroxide.

| | Spray A | Spray B | Spray C |
|---|---|---|---|
| Ethanol | 30 wt. % | 30 wt. % | 30 wt. % |
| Surfactant | APG | Fatty Acid | Alcohol Ethoxylate |
| pH | 13.1 | 13.1 | 13.1 |

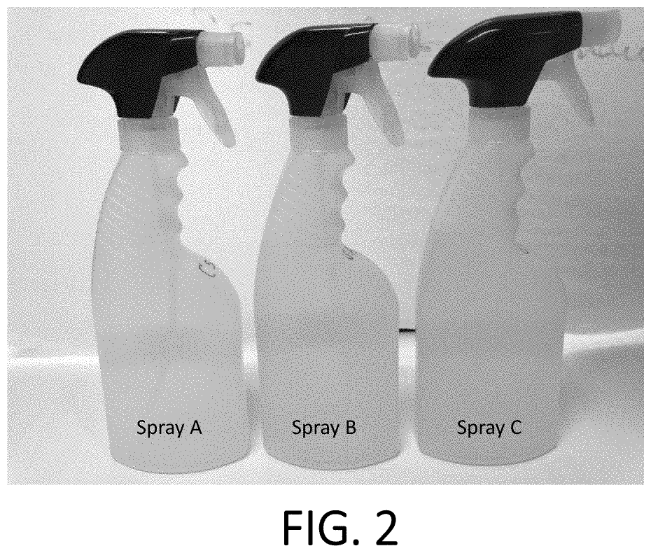

The shelf stability of the three surface sprays was observed by aging the three formulations under identical circumstances at 54° C. for five weeks. As shown in FIG. 2, Spray B, containing the fatty acid surfactant, exhibited significant yellowing after five weeks aging as compared to Sprays A and C.

### Example 3

Three fragrance-free surface sprays were prepared having identical compositions apart from the type of surfactant, as shown in Table 3. Each spray was prepared using identical amounts of ethanol and surfactant. The pH of each spray was adjusted to 13.0 using potassium hydroxide.

| | Spray D | Spray E | Spray F |
|---|---|---|---|
| Ethanol | 30 wt. % | 30 wt. % | 30 wt. % |
| Surfactant | Fatty Acid | APG | Alcohol Ethoxylate |
| pH | 13.0 | 13.0 | 13.0 |

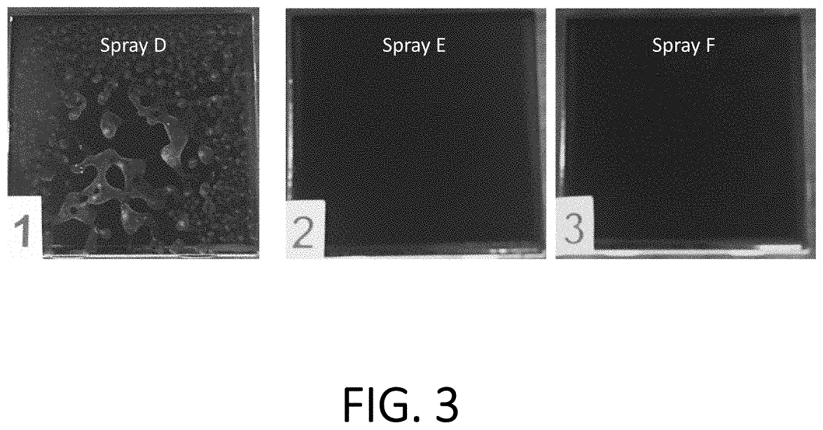

The visual residue of the three surface sprays was observed by spraying an identical amount of each surface spray onto a glossy black tile and allowing the samples to dry. As shown in FIG. 3, Spray D, containing the fatty acid surfactant, exhibited significantly greater visual residue as compared to Sprays E and F.

### Example 4

The same three fragrance-free surface sprays of Example 3 were then tested to assess their odor on surfaces after cleaning. Four 4×4 inch black ceramic tiles were provided, and each was washed with DI water and laboratory detergent and allowed to air dry. After drying, one tile remained untreated, and the three treatment tiles were each sprayed with one of surface sprays D, E, or F from Example 3, and allowed to dry. After drying, each of the three sprayed tiles were wiped with an acidic surface cleaning wipe and allowed to dry. After 4 hours, the three sprayed and one untreated tile were assessed by a 15-person panel, with the tiles presented in randomized order. Users assigned an odor intensity to each tile on a scale from 1 (no odor) to 10.

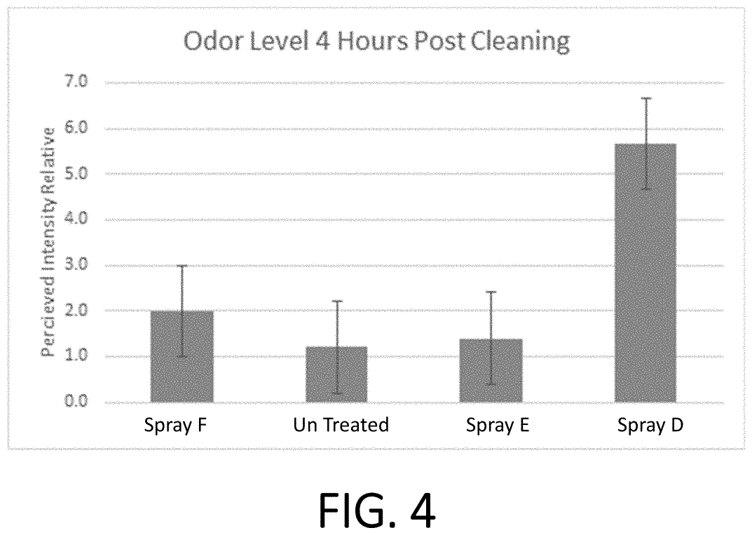

As shown in FIG. 4, the tile cleaned with Spray D, containing the fatty acid surfactant, exhibited a perceived odor intensity of between 5 and 6, as compared to the tiles cleaned with Sprays E and F as well as the untreated tile (each of which exhibited a perceived odor intensity between 1 and 2).

### Example 5

The effectiveness of various surface sprays against tuberculosis was observed, by preparing two fragrance-free surface sprays in identical composition to Spray D and Spray F of Example 3. As set forth in Table 4, the sprays were identical to one another apart from the type of surfactant. The pH of each spray was adjusted to 13.0 using potassium hydroxide.

| | Spray D | Spray F |
|---|---|---|
| Ethanol | 30 wt. % | 30 wt. % |
| Surfactant | Fatty Acid | Alcohol Ethoxylate |
| pH | 13.0 | 13.0 |

The effectiveness of the alkaline disinfecting compositions on hard, non-porous, inanimate environmental surfaces was studied according to the AOAC 961.02 test method, modified for tuberculocidal activity. Test cultures of Mycobacterium bovis (M. bovis) ATCC 35743 were used to test each compositions' efficacy. The cultures were applied to respective glass slides, dried, and sprayed with Spray D and Spray E, respectively, for the desired contact time. Once the contact time was reached, the glass slides were placed in a tube containing neutralizer and growth media. The tubes were incubated for 90 days at 36 degrees Celsius. After the 90 days, the tubes were examined for growth of M. bovis. In accordance with the testing methods, if any growth is observed, the respective spray is determined to fail in killing M. bovis at that specific contact time.

As shown in Table 5, at 3 minutes of contact time, growth of M. bovis was observed on the slide treated with Spray D, whereas no growth of M. bovis was observed on the slide treated with Spray F. Therefore, Spray D failed meeting the success criteria at 3 minutes, while Spray F passed. This data demonstrates the superior efficacy of the alcohol ethoxylate surfactant versus fatty acid-derived surfactants such as lauric acid.

| | | | Time |
|---|---|---|---|
| | Surfactant | Pass/Fail | (minutes) |
| Spray D | Fatty Acid | FAIL | 3 |
| Spray F | Alcohol Ethoxylate | PASS | 3 |

### Example 6

The efficacy of various alkaline disinfecting compositions against Staphylococcus aureus (S. aureus) was observed, both in surface spray and wipe form. For each formulation, potassium hydroxide was used to adjust to the given pH.

To study the surface sprays, three fragrance-free surfaces sprays were prepared having identical compositions apart from the type of surfactant, as shown in Table 6. Each spray was prepared using identical amounts of ethanol and surfactant.

| | Spray G | Spray H | Spray I |
|---|---|---|---|
| Ethanol | 30 wt. % | 30 wt. % | 30 wt. % |
| Surfactant | APG | Alcohol Ethoxylate | Fatty Acid |
| pH | 13.05 | 13.03 | 13.1 |

Further, two wipe samples were prepared, comprising alkaline disinfecting compositions as shown in Table 7.

| | Wipe J | Wipe K |
|---|---|---|
| Ethanol | 30 wt. % | 30 wt. % |
| Surfactant | APG | Fatty Acid |

The effectiveness of the alkaline disinfecting compositions on hard, non-porous, inanimate environmental surfaces was studied according to the AOAC 961.02 test method for the surface sprays, and according to the AOAC 961.02 method, modified for towelettes, for the wipes. Test cultures of S. aureus ATCC 6538 were used to test each compositions' efficacy, with a contact time of 1 minute for all samples. The results, set forth in Table 8, are expressed as a fraction of carriers that exhibited growth, e.g., percent positive carriers.

As shown in Table 8, the fatty acid spray and wipe samples exhibited a larger percentage of carriers positive than either the APG or alcohol ethoxylate samples, which illustrates that the APG and alcohol ethoxylate samples were more effective at killing S. aureus. This data demonstrates the superior activity of these nonionic surfactants to fatty acid-derived surfactants such as lauric acid.

| | | % | # of Carriers | |
|---|---|---|---|---|
| | Surfactant | Positive | Tested | Method |
| Spray G | APG | 2% | 220 | AOAC 961.02 |
| Spray H | Alcohol Ethoxylate | 6% | 180 | AOAC 961.02 |
| Spray I | Fatty Acid | 14% | 220 | AOAC 961.02 |
| Wipe J | APG | 8% | 40 | AOAC 961.02, |
| | | | | modified for |
| | | | | towelettes |
| Wipe K | Fatty Acid | 55% | 40 | AOAC 961.02, |
| | | | | modified for |
| | | | | towelettes |

I/We claim:

1. A sprayable composition comprising:
from 20 to 40 wt. % of one or more C₁-C₆ alcohols, based upon the total weight of the composition;
from 0.1 to 0.8 wt. % of one or more alkaline pH adjusting agents, based upon the total weight of the composition;
from 0.1 to 0.8 wt. % of one or more nonionic surfactants comprising one or more of alcohol ethoxylates, alcohol propoxylates, and alkyl polyglucosides; and
from 60 to 80 wt. % water, based upon the total weight of the composition,
wherein the composition has a pH of from greater than 12 to less than 14, and
wherein the composition is devoid of fatty acid-derived surfactants.

2. The composition of claim 1, wherein the disinfecting composition consists of the one or more C₁-C₆ alcohols, the one or more alkaline pH adjusting agents, the one or more nonionic surfactants, and the water.

3. The composition of claim 1, wherein the one or more nonionic surfactants consist of one or more of alcohol ethoxylates.

4. The composition of claim 1, wherein the one or more nonionic surfactants consist of one or more alkyl polyglucosides.

5. A sprayable composition comprising:
from 15 to 35 wt. % of one or more C₁-C₆ alcohols, based upon the total weight of the composition;
from 0.01 to 10 wt. % of one or more alkaline pH adjusting agents, based upon the total weight of the composition; and
from 0.01 to 10 wt. % of one or more nonionic surfactants comprising one or more of alcohol ethoxylates, alcohol propoxylates, and alkyl polyglucosides,
wherein the composition has a pH of greater than 12, and
wherein the composition is devoid of fatty acid-derived surfactants.

6. The composition of claim 5, wherein the composition has a pH of from greater than 12 to less than 14.

7. The composition of claim 6, wherein the composition has a pH of from 12.1 to 13.9.

8. The composition of claim 5, wherein the one or more nonionic surfactants consist of one or more C8-C14 linear alcohol ethoxylates.

9. The composition of claim 5, wherein the one or more nonionic surfactants consist of one or more C8-14 alkyl polyglucoside surfactants.

10-25. (canceled)

26. A composition comprising:
from 5 to 95 wt. % of one or more alcohols, based upon the total weight of the composition;
one or more alkaline pH adjusting agents; and
one or more nonionic surfactants,
wherein the composition has a pH of greater than 12, and
wherein the composition is devoid of fatty acid-derived surfactants.

27. The composition of claim 26, wherein the composition has a pH of from greater than 12 to less than 14.

28. The composition of claim 27, wherein the composition has a pH of from 12.1 to 13.9.

29. The composition of claim 26, wherein the one or more alcohols comprise from 15 to 35 wt. %, based upon the total weight of the composition.

30. The composition of claim 26, wherein the one or more nonionic surfactants comprise from 0.01 to 10 wt. %, based upon the total weight of the composition.

31. The composition of claim 26, wherein the one or more alkaline pH adjusting agents comprise from 0.01 to 10 wt. %, based upon the total weight of the composition.
